(19) United States
(12) Patent Application Publication
(10) Pub. No.: US 2018/0232677 A1
(43) Pub. Date: Aug. 16, 2018

(54) METHOD AND SYSTEM FOR QUALITY AUDITING OF A SPA ASSET

(71) Applicant: Cheryl Ann Adonizio, Windermere, FL (US)

(72) Inventor: Cheryl Ann Adonizio, Windermere, FL (US)

(21) Appl. No.: 15/897,061

(22) Filed: Feb. 14, 2018

Related U.S. Application Data
(60) Provisional application No. 62/459,848, filed on Feb. 16, 2017.

(51) Int. Cl. G06Q 10/06; G06Q 40/00

(52) U.S. Cl. CPC G06Q 10/06393; G06Q 40/12; G06Q 10/06395

(57) ABSTRACT

The novel invention provides various methods and a system of converting disparate observations together with financial and other data into usable business information for hotel owners about their spa assets in order to increase the value of that those assets by measuring the quality of the guest experience, the efficiency of operations and financial performance of those assets.

This application claims priority on Provisional Application Ser. No. 62/459,484 filed Feb. 15, 2017

### US PATENT REFERENCES

Ser. No. 20090138425
Ser. No. 20140114728
U.S. Pat. No. 9,697,490
Ser. No. 20030158749
Ser. No. 20150193719

### BACKGROUND OF THE INVENTION

The present invention is in the technical field of converting disparate observations together with financial data, into raw data and then into usable information. More particularly, the present invention is in the technical field of converting these disparate observations, financial and other data from a hospitality industry specific source such as a hotel spa asset and then converting that data, into usable information to improve the quality, operations and financial performance of that asset.

Many hotel owners strive to be competitive in the hotel marketplace, to attract more guests and to increase profits.

One way they have sought to accomplish this goal is by offering a spa facility at their hotels. In fact it is estimated that, over 2000 spas have been added to hotels worldwide in the past 20 years. However, having or adding a spa asset to a hotel does not automatically accomplish the owner's goals since the spa asset must also attain certain level of perceived quality, operational efficiency and financial performance, as well.

For the hotel spa asset to remain top quality, to achieve operational efficiency and to produce the financial results desired by the owner, controls, standards and goals must be put in place and consistently met. However those controls, standards and goals are meaningless unless they can be measured objectively on a consistent basis.

### BRIEF SUMMARY OF THE INVENTION

The present invention is a method and system whereby spa assets can regularly, consistently and objectively be assessed for quality, operational efficiency, financial and other types of performance metrics, including exposing any gaps between management's perception of performance and a more objective reality.

The method and system includes the steps of obtaining information by an objective third party called the auditor (referred to as the auditor or auditor user throughout) and entering that information into the system. A questionnaire, called the Audit Questionnaire is used to guide the recording of information about operations, finance, and guest experience. Additionally, hospitality or spa management is also asked to complete a small number of questions which are entered into the system by the auditor.

The data is Input into the system by answering the Audit Questionnaire questions, and when complete the core process, called the Audit Process begins with the data being analyzed and Raw Scores being looked up in the Audit Score Database. All relevant operational categories are determined by what questions were or were not answered and input and become the Operational Categories Subset. Category Weights are calculated using the subset and then applied to the Raw Scores to get the Weight Adjusted Scores for the Operational Scorecard.

If management has answered their portion of the Audit Questionnaire, then additional values are calculated in the exact same manner as the steps above, in the Forecast Sub-process. The above steps, described again here, are repeated using certain management answers instead of auditor answers. The process repeats starting with data being analyzed and The Raw Scores looked up in the Audit Score Database, the relevant operational categories are determined by which questions were or were not answered and become the Operational Categories Subset, Category Weights are calculated using the subset and then applied to the Raw Scores to derive the Weight Adjusted Scores for the Forecast Results. The Forecast Results are added to the Operational Scorecard and are not mandatory. If management did not answer their portion of the Audit Questionnaire this Forecast Sub-process will not take place.

The values calculated from the Audit Process, and the Forecast Sub-process, if any, will be organized and ready for output in the Operational Scorecard and Forecast Results.

In addition to the core Audit Process and Forecast Sub-process as described above, two additional processes exist in the preferred embodiment of the invention, the Narrative Process and the Benchmark Process.

The concurrent process called the Narrative Process allows for the Output of more subjective, anecdotal information which can provide depth and understanding of the values derived from the objective core Audit Process. If the auditor has answered and Input certain narrative questions in the Audit Questionnaire, the process will proceed to matching the detailed anecdotal information with the proper category and then organizing the information for output into the Experience Narrative. If the auditor did not provide answers to any narrative questions, then this process would not take place.

Another concurrent process, called the Benchmark Process allows for the comparison of certain metrics to key financial numbers for the spa asset. Benchmarks could include a broad range of metrics including industry standards, peer averages and past asset performance values. If certain key financial questions were answered in the Audit Questionnaire and Input then the Benchmark Process will proceed to matching the appropriate benchmarks by lookup in the Benchmark Database and obtaining the Relevant Benchmark Values. Calculations are performed to compare the Benchmark values and Key Financials, and organized in the Benchmark Scorecard which is readied for Output. If the auditor did not answer and Input key financials then this process would not take place.

In the preferred embodiment of the invention, the Audit Process, the Forecast Sub-process, the Narrative Process, and the Benchmark Process would all take place as a result of a thoroughly completed Audit Questionnaire and product displayed in the Audit Results is an in-depth and objective snapshot of the performance of the operations, finance and quality of the spa asset that can be used to detect gaps and improve performance on a consistence basis.

### BRIEF DESCRIPTION OF THE DRAWING

FIG. 1. is a flow-diagram overview of all processes and methods of the preferred embodiment of the present invention for auditing a spa asset;

FIG. 2. is a flow-diagram of the core audit process and forecast steps detail of the present invention for auditing a spa asset;

FIG. 3. is a flow-diagram of detailed steps of a narrative process of the present invention for auditing a spa asset

FIG. 4. is a flow-diagram of detailed steps of a benchmark process of the present invention for auditing a spa asset.

### DETAILED DESCRIPTION OF THE INVENTION

Referring now to the invention in greater detail wherein various embodiments will be described more fully and with reference to the accompanying illustrations and tables. All elements of the illustrations are numbered consistently throughout.

The system may be described as having a computer or mobile computing device such as a tablet or mobile phone and a server or servers. In the preferred embodiment of the invention the system may include a remote server or servers that warehouse the databases described herein. However in a lesser version of the invention the databases can be local to the computing device.

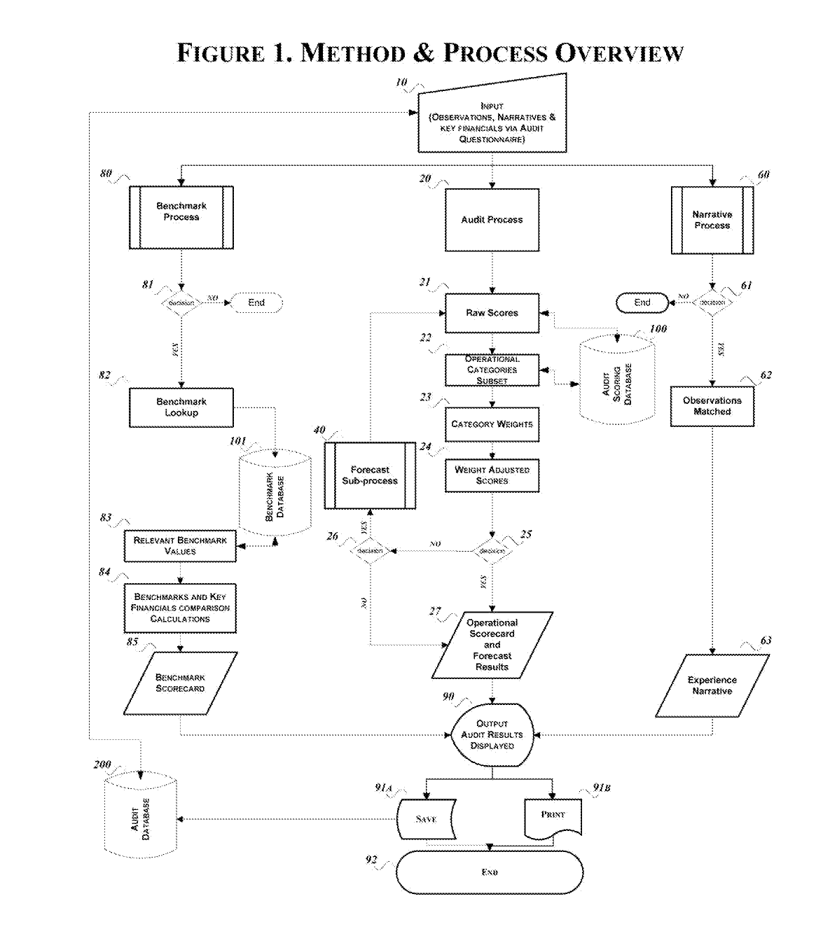

The following detailed description of the invention refers to FIG. 1., which is a flow-diagram overview of all processes and methods of the preferred embodiment of the present invention for auditing a spa asset, unless otherwise specifically noted.

All processes are dependent on the unique data of the individual spa which is gathered and input by the auditor who is also referred to as auditor user throughout. The auditor gathers data through their own observation and other means including gathering current financial information about the spa asset as well as obtaining management's perception of the asset's performance. Once the data is collected entered into the system it is referred to as a data or data point(s). There can be any number of observations and data collected for processing by this invention, however the greater number of data points the richer the output. In an ideal embodiment of the invention there could be as many as 350 different data points or more across 15 or more different operational categories that measure a broad range of spa asset attributes including but not limited to, general attributes, financial type attributes, managerial type attributes, operations type attributes, inventory managements type attributes, human resource type attributes, sales type attributes, marketing type attributes and guest experience type attributes. Attributes and categories are used interchangeable throughout.

In addition to the auditor observations and collected data, the preferred embodiment of the invention would include hospitality management's own predictions and performance expectations. The degree of disparity between the perceived spa asset performance and the actual results can assist in improving the performance of that asset by exposing gaps. This comparison is embodied in the Forecast Sub-process described in detail below.

All observations and all gathered data regardless of source are entered into the system by the auditor answering a series of questions organized into the Audit Questionnaire (See Table 1: Audit Questionnaire Sample Questions.) These questions can come in a range of formats including, binary choice, open-ended, close-ended and scaled. The answers to these questions as said, become data points upon being entered, Input 10. Since not all spa operations are identical not all questions must be answered in order to initiate the Audit Process and/or other processes and obtain meaningful Audit Results. Weighting calculations described herein give the invention the flexibility to audit, a wide range of spa assets regardless of their differences in operations.

Further, in the preferred embodiment of the invention, the Input 10 or data points, are saved automatically, to the Audit Database 200, allowing the auditor user to answer questions in any order, skip ahead or go back, review, update or leave and return as many times necessary to complete the Audit Questionnaire.

The Input 10, in the ideal embodiment of this novel invention, is entered directly into a computing device which can be a computer, or mobile computing device such as a tablet or mobile phone; or in a somewhat lesser version of the invention can be recorded on paper and then entered at a later time into the computing device.

All observations and other gathered data are entered at the beginning of the process, Input 10, and utilized by various processes at various times.

The core Audit Process 20, is initiated on command when Input 10, is complete to the satisfaction of the auditor user.

Raw Scores 21, are produced by data point lookup in the Audit Score Database 100. In other words each answer to a question which is turned into a data point has been assigned a value or score. In this step all data is analyzed to determine the Raw Scores, 21.

Again since not all spa operations are identical, weight calculations are used to standardize results across a plurality of spas. Each question in the Audit Scoring Database 100 has assigned to a category and each category is assigned a relative weight indicative of the relative importance of that operational category in the overall operational process.

After the Raw Scores 21 are calculated, weighs are calculated thusly. First it is determined which questions were answered or not answered to assess if any categories were completely omitted. In other words was an entire category of questions not answered, if so it is not included in the Operational Categories Subset 22. Instead only categories that contain a one or more data points are considered going forward.

Once the Operational Category Subset 22 is determined then weights are calculated for each category in the subset creating Category Weights 23.

The calculated Category Weights 23, are applied to the Raw Scores 21 to arrive at Calculated Weighted Scores 24.

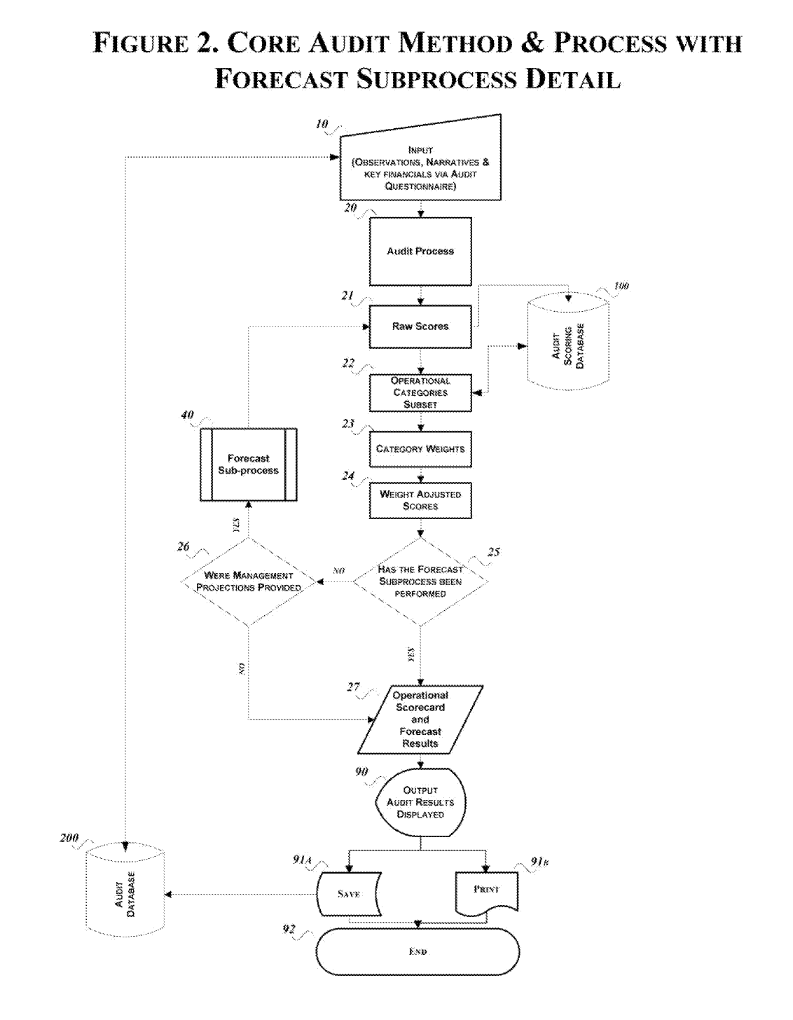

At this juncture, there are two Decisions 25 and 26 that work together to initiate or bypass the Forecast Sub-process. How these work together can be seen in FIG. 1. in general and FIG. 2 in detail. Firstly, to avoid an endless loop the sequence of Decisions 25 and 26 seems counter intuitive as to the order, but they are organized as such to avoid a loop. Therefore, the first decision, Decision 25 determines if the Forecast Sub-process 40 has been performed as evidenced by Forecast Results. If the answer is Yes, then the Forecast Results are included with the Operational Scorecard. If the Forecast Sub-process 40 has not been performed and there are no Forecast Results then, the answer is No and a second decision must be made. Decision 26 asks, if at the onset of the process, Input 10, were management predictions entered. If the answer is No to Decision 26 then the Forecast Sub-process 40 will not take place and the process resumes as described below. If the answer to Decision 26 is yes then the Forecast Sub-process 40 will proceed as detailed below.

If the Forecast Sub-process 40, is not performed then the Weight Adjusted Scores 24 are organized into the Operational Scorecard and Forecast Results 27 but without forecast results and readied for output.

If the Forecast Sub-process 40, does take place, it follows the exact same steps as the Audit Process 20, but the steps are performed using only the observations and data of management that were input by the auditor user. These steps include, Raw Score 21 lookup, Operational Category Subset 22 determination, Category Weights 23 calculated, and Weight Adjusted Scores 24 applied.

The weighted scores are organized into Forecast Results, and then results are included in the Operational Scorecard and Forecast Results 27. Noting that the answer to Decision 25 which can be seen in general in FIG. 1. and in specific in FIG. 2, is Yes and therefore the process proceeds with the Forecast Results.

In addition to the core Audit Process 20 with or without the additional Forecast Sub-process 40, the preferred embodiment of the invention is comprised of two additional processes the Narrative Process 60 and the Benchmark Process 80 which further serve to understand the spa performance and identify areas of improvement. The core Audit Process 20 with or without the additional Forecast Sub-process 40 is not dependant on either of these additional processes.

The Narrative process allows for more in-depth, subjective anecdotal observations. These longer and detailed observation narratives can give greater insight into different aspects of the spa asset and may further explain certain objectively measured outcomes.

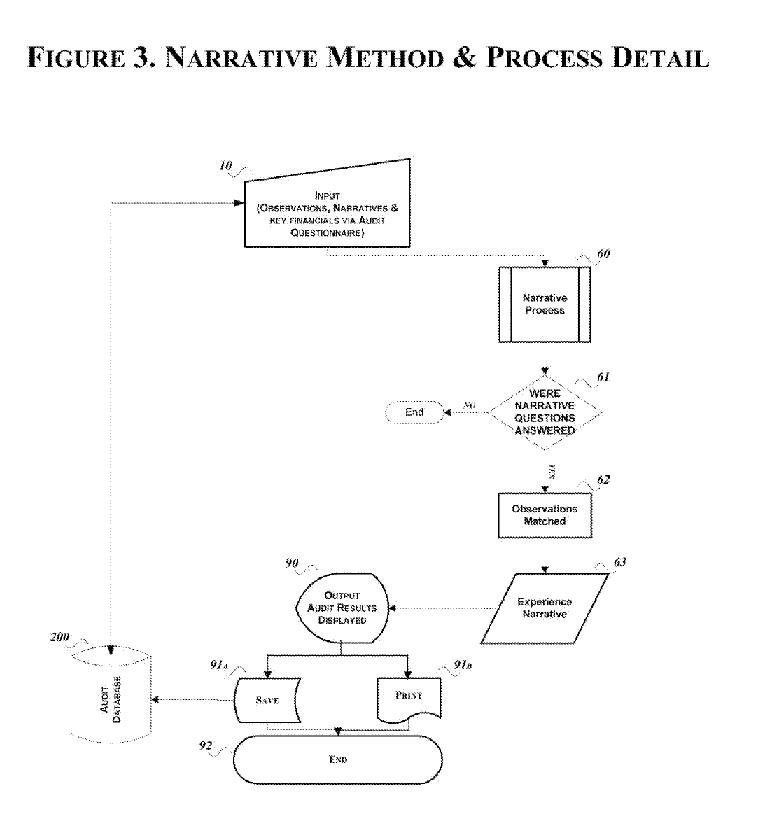

The Narrative Process 60 shown in FIG. 1 and detailed in FIG. 3, initiates with Decision 61. If at the onset, Input 10, one or more open ended narrative questions have been answered by the auditor, then the Narrative Process 60, proceeds. If no open-ended, narrative questions were answered at the onset, Input 10, then the Narrative Process ends.

If the Narrative Process 60, proceeds, then those anecdotal observations are matched to the appropriate category, Observations Matched 62.

The matched anecdotal observations are organized into the Experience Narrative 63 and ready for output.

Another process, in the preferred embodiment of the invention is the Benchmark Process 80. This process allows for a comparison of specific key financial performance data of the spa asset to a wide range of spa industry standards, peer averages, past audit scores and/or any number or variety of other business metrics. This too can serve as a means of identifying areas of improvement of the spa asset.

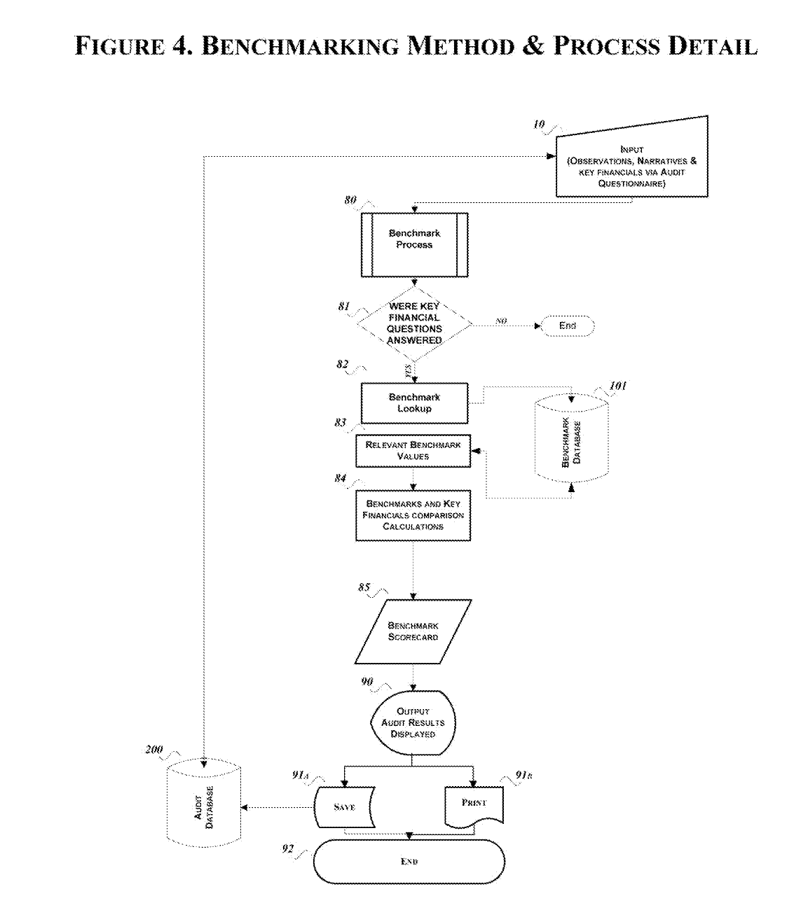

The Benchmark Process 80 shown in FIG. 1, and detailed in FIG. 4. proceeds to Decision 81. If at the onset, Input 10, one or more key financial performance numbers were input, then the Benchmark Process 80, will proceed. If no key financial performance numbers were input at the onset of the entire process, Input 10 then this process ends.

If the Benchmark Process 80, proceeds, then the next step is to determine which benchmarks are relevant to each key financial number entered. This Benchmark Lookup 82, is done by lookup in the Benchmark Database 101. Each Benchmark in the Benchmark Database 101, is pre-assigned to a key financial data number.

Once the proper benchmark(s) are identified, then the Relevant Benchmark Values 83, are determined also from Benchmark Database 101. It should be noted that some benchmark values, such as peer averages are variable and published annually by industry associations while other benchmark values are static and have become standard industry values. Because some of the most critical benchmarks are annually updated, the preferred embodiment of the invention contemplates an update to the Benchmark Database 101 at least annually.

After the benchmark values are ascertained, the Benchmark(s) and Key Financials Comparison Calculations 84 are performed to assess the relative performance of the spa asset at that moment in time.

The results of the Benchmarks and Key Financials Comparison Calculations 84, are organized in a Benchmark Scorecard 85 and ready for output.

In the final steps of the preferred embodiment of the invention, the Operational Scorecard 27, including Forecast Results, in addition to the Experience Narrative(s) 63 and the Benchmark Scorecard 85 all having been organized are output to a display. Output Audit Results Displayed 90 are displayed to the screen of the computer or mobile device including a tablet or mobile phone.

Once displayed, the results can be Printed 91B to a device or to file, or Saved 91A to the Audit Database 200, or both.

Once the results are Save(d) 91A and/or Print(ed) 91B all processes comes to an End 92.

What is claimed is:

1. A method of auditing of a spa asset comprising:
a) performing an analysis of data of the spa asset;
b) calculating raw scores through data analysis;
c) determining relevant operational categories of the data being analyzed;
d) obtaining each operational category's relative weight;
e) applying the relative weights to the raw scores.

2. The method according to claim 1 wherein the analysis of data of the spa asset includes operational data

3. The method according to claim 1 wherein the analysis of data of the spa asset includes financial data

4. The method according to claim 1 wherein the analysis of data of the spa asset includes guest experience data

5. The method according to claim 1 wherein the operational category is a guest experience category.

6. The method according to claim 1 wherein the operational category is an inventory management category.

7. The method according to claim 1 wherein the operational category is a financial category.

8. The method according to claim 1 wherein the operational category is a sales and marketing category.

9. The method according to claim 1 wherein the operational category is a personnel category.

10. The method according to claim 1 wherein the operational category is a facilities category.

11. The method for auditing a spa asset in claim 1 further comprising forecast steps wherein all steps repeat and the data is the performance projections from the management of the spa asset.

12. The method for auditing a spa asset in claim 1 further comprising narrative steps of:
a) performing an analysis of data of the spa asset;
b) matching the data to the proper operational category.

13. The method according to claim 14 wherein the analysis of data of the spa asset includes anecdotal data.

14. The method according to claim 14 wherein the operational category is a guest experience category.

15. The method according to claim 14 wherein the operational category is an inventory management category.

16. The method according to claim 14 wherein the operational category is a financial category.

17. The method according to claim 14 wherein the operational category is a sales and marketing category.

18. The method according to claim 14 wherein the operational category is a personnel category.

19. The method according to claim 14 wherein the operational category is a facilities category.

20. The method for auditing a spa asset in claim 1 further comprising benchmark steps of:
a) performing an analysis of data of the spa asset;
b) looking up the relevant benchmarks for the data;
c) obtaining the benchmarks values;
d) comparing the benchmark values and data.

21. The method according to claim 24 wherein the data of the spa asset includes key financials.

22. A system for auditing of a spa asset comprising:
a) a means for performing an analysis of data of the spa asset;
b) a means for calculating raw scores through data analysis;
c) a means for determining relevant operational categories of the data being analyzed;
d) a means for obtaining each operational category's relative weight;
e) a means for applying the relative weights to the raw scores.

23. The system for auditing a spa asset in claim 29 further comprising a means of forecast steps wherein all steps repeat and the data is the performance projections of the management of the spa asset.

24. The system for auditing a spa asset in claim 29 further comprising a means of narrative steps of:
a) performing an analysis of data of the spa asset;
b) matching the data to the proper operational category.

25. The system for auditing a spa asset in claim 29 further comprising a means of benchmark steps of:
a) performing an analysis of data of the spa asset;
b) looking up the relevant benchmarks for the data;
c) obtaining the benchmarks values;
d) comparing the benchmark values and data.
